(19) United States
(12) Patent Application Publication
(10) Pub. No.: US 2002/0184128 A1
(43) Pub. Date: Dec. 5, 2002

(54) System and method for providing music management and investment opportunities

(76) Inventor: Matt Holtsinger, Dacula, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/043,866

(22) Filed: Jan. 11, 2002

Related U.S. Application Data
(60) Provisional application No. 60/261,420, filed on Jan. 11, 2001.

(51) Int. Cl. G06F 17/60

(52) U.S. Cl. 705/35; 705/36

(57) ABSTRACT

A system and methods for providing music management and investment opportunities is disclosed. In a simplified embodiment, the system comprises a memory having a peer-tuner application and a music investment server application therein; a local database comprising a local peer-tuner portion and a local music investment server portion; and a processor programmed by the peer-tuner application and the music investment server application. The processor is programmed by the peer-tuner application to perform the steps of: connecting the local system with at least one remote system having the peer-tuner application therein; allowing a user of the local system to download benchmark music received from the remote system to the local peer-tuner portion of the local database, after connecting the local system with the remote system, wherein the benchmark music received by the local system, from the remote system, is removed from the local peer-tuner portion of the local database when the connection between the local system and the remote system is ended; and allowing the user to purchase the benchmark music received from the remote system. In addition, the processor is programmed by the music investment server to perform the steps of: providing the user of the remote system with an option to purchase the benchmark music; and allowing a user of the local system or the remote system to invest in potential sales of the benchmark music.

### CROSS-REFERENCE TO RELATED APPLICATIONS

This application claims the benefit of U.S. provisional application serial No. 60/261,420, filed Jan. 11, 2001, and entitled “A System and Method for Providing Music Management and Investment Opportunities,” which is incorporated by reference herein in its entirety.

### FIELD OF THE INVENTION

The present invention relates generally to the music industry. More specifically, the present invention relates to a direct music investment system and method for expediting the introduction of music to consumers and providing investment opportunities.

### BACKGROUND OF THE INVENTION

The trend of music instrument technology is moving through digitalization and computerization, with increasing ranges of expression, accuracy in modulation, and fidelity of reproduction. With the introduction of the Internet age of ubiquitous communication, new musical content is being transmitted across digital channels.

The music industry, however, has been built on an infrastructure of scarcity. As an example, there is a finite amount of rack space available for selling compact discs (CD's) in music stores; there is a finite amount of bandwidth on radio stations for listening to music; and, when CD's can cost twenty dollars ($20) or more, there is a finite amount of money that a typical consumer will spend to obtain musical content.

The music industry traditionally spends excessive time and money on high quality production and promotion of relatively few musical artists. Since the music industry focuses on relatively few musical artists and their work, variety in musical choices is reduced, as well as the amount of personalization of music available to consumers. In addition, recording companies may choose not to promote the most talented artists, but instead, may choose to select to promote the work of artists with whom the recording companies have the most profitable contracts. The above mentioned control over musical content renders music consumers captive to the selections of recording companies, producers, and/or promoters of the music industry.

With the introduction of MPEG-1 Audio Layer-3 (MP3) file sharing networks, as well as other file sharing networks, different categories and sources of music have been introduced to the public via use of the Internet. Artist names and song titles may now routinely be used to identify music, not for the purpose of purchasing, but as search strings for music to be obtained on the Internet without artist permission.

The music industry has begun responding to the challenge of music availability without artist permission by building more secure music distribution systems on the Internet. These systems not only prevent the copying of music without artist permission, but the secure music distribution systems help music listeners ensure that music they are accessing is not being obtained without consent of the artist whom created the music.

Within these systems, music companies have begun using personalization technologies to channel an even larger variety of music to the music consumer. This more customized listening experience not provides a music company with an opportunity to sell a greater variety of music, but the individual customer friendliness and responsiveness of the system might persuade some customers to desist from obtaining music without artist permission.

Automated Collaborative Filtering (ACF) of information is one personalization technology used for distribution of opinions and ideas and for facilitating contacts between individuals with similar musical, as well as other, interests. ACF allows performance of information searches with human intelligence, but at machine speeds. Specifically, ACF utilizes the recording of individual opinions on the importance and quality of particular material (i.e., music), and uses the recordings to improve the results of computer searches. Therefore, ACF automates and enhances existing mechanisms of knowledge distribution and dramatically increases the speed and efficiency the mechanisms. As a result, ACF optimizes knowledge flow and provides a superior tool for information retrieval systems that facilitates user navigation for information in a meaningful and personalized manner.

Unfortunately, ACF currently has significant problems, a few of which are described below. First, in order to be the most effective, the algorithms used by ACF for recommending specific music for specific consumers, needs to access an entire database of both potential music selections and listeners. The required calculations by these algorithms for analyzing and sorting the entire database are also highly processor intensive. In addition, since the results of queries to the distribution system are typically ranked selections derived from statistical groups, highly unique musical selections made by highly unique individuals may never be introduced to other listeners.

ACF calculations also take place in a close source, centralized system. Because music listeners cannot directly view all input and calculations performed during ACF, the listeners may not completely trust the output of the distribution system. Indeed, the listener concerns may be valid since business models of some ACF systems factor in associated profit margins of potential recommendations. Given the lack of trust that many music consumers already have with the music industry, even the potential for the industry to abuse an ACF system may sufficiently deter many music listeners from using the ACF systems.

Other personalization systems have been developed using the recommendations of known friends within a buddy list. This can be effective because in many instances, friends are known to have similar tastes in music. However, musical tastes may change faster than relationships. Spending time within a buddy list system means spending less time outside the system finding new music. Also, a buddy list system encourages chatting and other communication. While most people value the recommendations of people with similar tastes, many simply want to listen to music, and do not wish to chat or directly interact with others on the Internet.

In some form, personalization technology does have the potential to improve the music listening experience however, it is clearly limited when simply used as an addition to the business models of record companies, producers, and/or promoters.

### SUMMARY OF THE INVENTION

In light of the foregoing, the present invention provides a system and method for providing music management and investment opportunities. The system and method fosters a broader definition of creative musicians and record companies, and provides the public with the opportunity to be rewarded sonically by hearing music similar to their taste, and financially by allowing the public to invest in, and be rewarded, based on the commercial success of creative works.

The system comprises a memory having a peer-tuner application and a music investment server application therein; a local database comprising a local peer-tuner portion and a local music investment server portion; and a processor programmed by the peer-tuner application and the music investment server application. The processor is programmed by the peer-tuner application to perform the steps of: connecting the local system with at least one remote system having the peer-tuner application therein; allowing a user of the local system to download benchmark music received from the remote system to the local peer-tuner portion of the local database, after connecting the local system with the remote system, wherein the benchmark music received by the local system, from the remote system, is removed from the local peer-tuner portion of the local database when the connection between the local system and the remote system is ended; and allowing the user to purchase the benchmark music received from the remote system. In addition, the processor is programmed by the music investment server to perform the steps of: providing the user of the remote system with an option to purchase the benchmark music; and allowing a user of the local system or the remote system to invest in potential sales of the benchmark music.

### BRIEF DESCRIPTION OF THE DRAWINGS

The present invention will be more fully understood from the accompanying drawings of he embodiments of the invention, which however, should not be taken to limit the invention to the specific embodiments enumerated, but are for explanation and for better understanding only. Furthermore, the drawings are not necessarily to scale, emphasis instead being placed upon clearly illustrating the principles of the invention. Finally, like reference numerals in the figures designate corresponding parts throughout the several drawings.

FIG. 1 is a block diagram illustrating a typical computer or processor-based system in which the present music management and investment system may be provided.

FIG. 2 is a block diagram further illustrating a memory located within the computer system of FIG. 1.

FIG. 3 is a block diagram further illustrating a database located within the computer system of FIG. 1 and interaction between a local peer tuner portion of the database, a local music investment server portion of the database, and a remote peer-tuner portion of a remote database.

FIG. 4 is a flowchart that further illustrates interaction between a user, the peer-tuner located within the memory of FIG. 2, and the music investment server located within the memory of FIG. 2.

FIG. 5 is a flowchart that further illustrates installation and initialization of the peer-tuner located within the memory of FIG. 2.

FIG. 6 is a flowchart that further illustrates the process of logging into the music investment server, in addition to resulting actions performed by the music investment server and peer-tuner.

FIG. 7 is a flowchart further illustrating connection of the peer-tuner with a peer network formed from a list of available remote peers.

FIG. 8 is a flowchart further illustrating the autonomous mode of operation.

FIG. 9 is a block diagram illustrating an example of decisions performed by an algorithm utilized to determine how one peer-tuner calculates how closely its associated music profile string table matches the music profile string table associated with another peer.

### DETAILED DESCRIPTION

The music management and investment system of the present invention can be implemented in software, firmware, hardware, or a combination thereof In the preferred embodiment of the invention, which is intended to be a non-limiting example, a portion of the music management and investment system is implemented in software that is executed by a computer, for example, but not limited to, a server, a personal computer, work station, minicomputer, or main frame computer. It should be noted, however, that the present invention may be provided entirely of hardware or entirely of software.

The software based portion of the music management and investment system, which comprises an ordered listing of executable instructions for implementing logical functions, can be embodied in any computer-readable medium for use by, or in connection with, an instruction execution system, apparatus, or device such as a computer-based system processor containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus or device.

The computer-readable medium can be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disk read-only memory (CD ROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner, if necessary, and then stored in a computer memory.

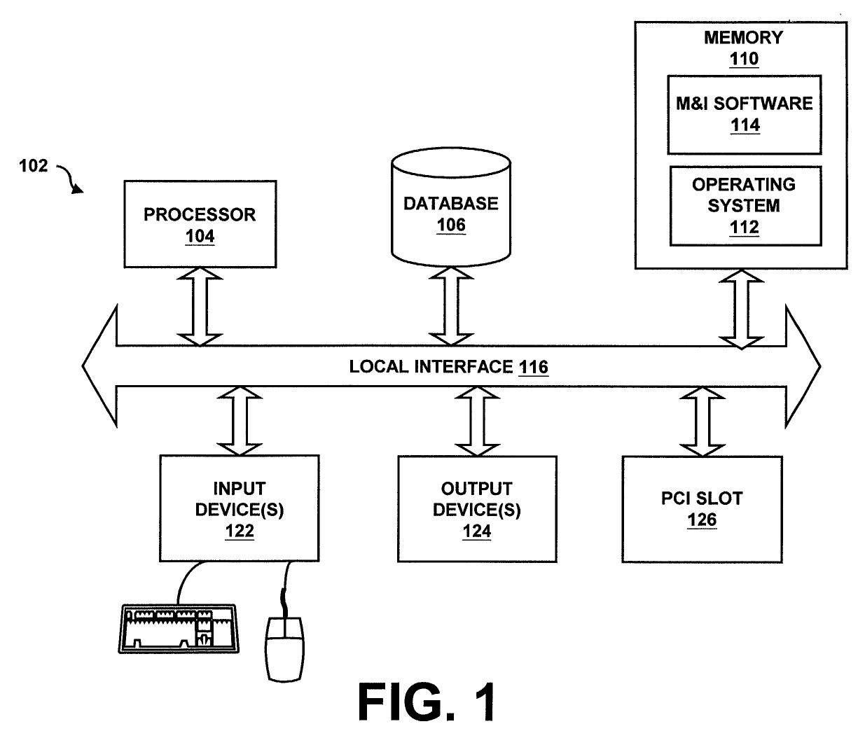

Referring now to the drawings, wherein like reference numerals designate corresponding parts throughout the drawings, FIG. 1 is a typical computer or processor-based system 102 in which the present music management and investment system of the present invention may be provided if the music management and investment system is either partially or entirely provided via software. The computer system 102 generally comprises a processor 104, a database 106, and a memory 110. Herein, the memory 110 may be any combination of volatile and/or nonvolatile memory elements, such as random access memory or read only memory.

The memory 110 further comprises an operating system 112 and music management and investment software 114. Generally, the computer system 102 may run any of a number of different platforms and operating systems, including, but not limited to, Windows NT™, Unix™, or Sun Solaris™ operating systems. The software 114 defines instructions to be performed by the processor 104 in accordance with the requirements of the present music management and investment system. The instructions are accepted by the processor 104 from the memory 110 over a local interface 116, such as a bus(es). It should be noted that the memory 110 also may define functions to be performed by the computer system 102 that are typical of most computer systems.

The computer system 102 also comprises an input device(s) 122 and an output device(s) 124. Examples of input devices may include, but are not limited to, a keyboard, a mouse, a scanner, or a local access network connection. Examples of output devices may include, but are not limited to, a video display, a Universal Serial Bus (USB), or a printer port. A PCI sot 126 is attached to the local interface 116 and provides a means for a peripheral device, such as a network interface card (NIC), to attach to the computer system 102.

It should be noted herein that, while the present disclosure is provided with reference to the music industry, it should be noted that the system and method provided herein may instead be focused upon any artistic medium. Examples of artistic mediums may include, but are not limited to, paintings or movies.

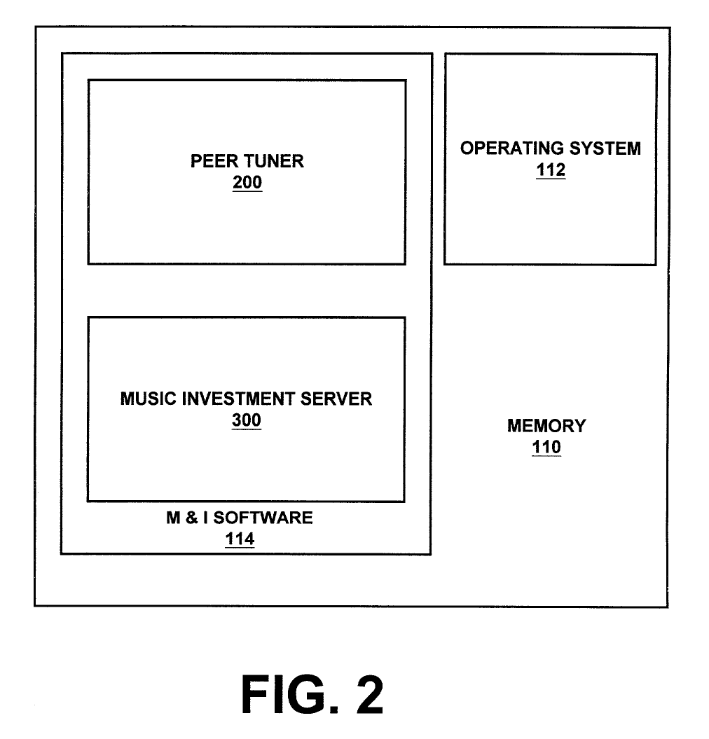

FIG. 2 is a block diagram further illustrating the memory 110 of FIG. 1. As shown by FIG. 2, the music management and investment software 114, located within the memory 110, further comprises a peer-tuner application 200, referred to herein as a “peer-tuner,” and a music investment server application 300, referred to herein as a “music investment server.” The peer-tuner 200 allows connection to, and interaction with, other peer-tuners located on computer systems remote from the present computer system 102. In fact, physical locations of peer-tuners may include, but are not limited to, peer-tuners being connected to each other via the Internet, or locally located within a local access network. Connections between peer-tuners are made in accordance with user similarities of musical taste, as is described in detail below.

The music investment server 300 is preferably a single application that may be used by peer-tuners 200 for listening to music and for providing opportunities to invest in music that is distributed through the music investment server 300 and/or peer-tuners 200. The music investment server 300 is described in detail below. In addition to the peer-tuner 200 and the music investment server 300, the memory 110 comprises the operating system 112, as is mentioned with reference to FIG. 1.

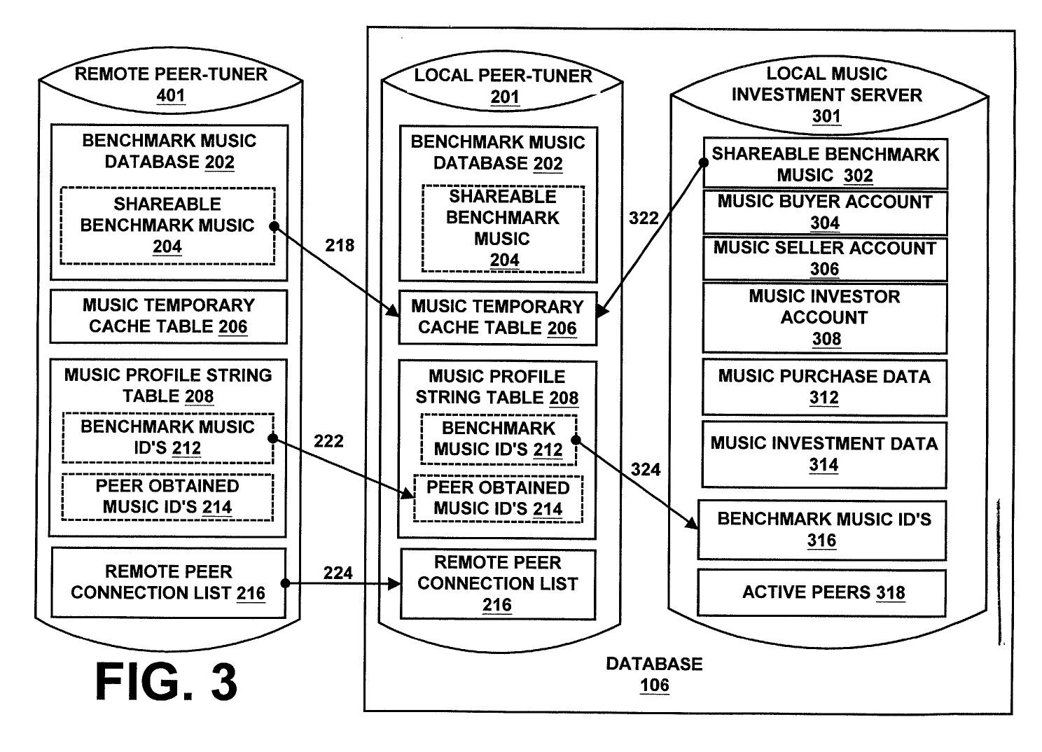

FIG. 3 is a block diagram further illustrating the database 106 of FIG. 1 and interaction between a local peer tuner portion of the database 201, a local music investment server portion of the database 301, and a remote peer-tuner portion 401. It should be noted that the remote peer-tuner portion 401 is located in a remote database located external from the present computer system 102 (FIG. 1). The local peer-tuner portion 201 comprises a benchmark music database portion 202. The benchmark music database portion 202 comprises music that has been purchased by a user of the computer system 102 (FIG. 1), wherein the user has obtained personal listening rights upon purchase of the music. It should be noted that the user may also be provided with ownership and/or distribution rights to the music. The music within the benchmark music database portion 202, also referred to herein as benchmark music, may also be provided by the creator of the music or another individual or entity having ownership and/or distribution rights to the music. Music within the benchmark music database portion 202 is therefore representative of the musical taste of the user of the computer system 102.

Globally unique benchmark identifications (IDs), also referred to herein as benchmark music IDs, may be generated by the benchmark music database portion 202 for benchmark music that is representative of the musical taste of the user. The benchmark music database portion 202 may also be used to generate sharable music 204, referred to hereafter as shareable benchmark music. Therefore, sharable benchmark music 204 is also representative of the musical taste of a specific user, wherein the user is the user of the computer system 102 (FIG. 1) upon which the local peer-tuner portion 201 is stored. Music may be shared via permission of the creator of the music or, if the creator of the music does not possess all rights to the music, by the copyright holder of the music.

It should be noted that, in accordance with an alternate embodiment of the invention, music samples may be stored and shared as opposed to entire musical selections, or songs. Musical samples may comprise a shortened version of and entire musical selection, or song. In addition, musical selections may be compressed shortened versions of an entire musical selection.

The local peer-tuner portion 201 also comprises a music temporary cache table 206 in which copies of shareable benchmark music 204 from a remote peer-tuner portion 401 may be temporarily stored, as shown by transmission line 218. Preferably, the music temporary cache table 206 is provided within a database 106 that is a secure database that does not allow copying of data by the file management capabilities of the computer system 102 (FIG. 1). Alternatively, the portion of the database 106 comprising the music temporary cache table 206 may be a secure portion that does not allow copying by the file management capabilities of the computer system 102 (FIG. 1). As is further discussed below, use of a secure database as the music temporary cache table 206 enables complete removal of shareable benchmark music from the database 106 when a connection with a remote computer system, having a remote peer tuner portion 401 therein, from which the shareable benchmark music sample was received, is disconnected from a local computer system 102, having the local peer tuner portion 201 therein. In addition, it is preferred that the user having the shareable benchmark music located on their computer system, have the legal right to distribute shareable benchmark music.

The music temporary cache table 206 may also temporarily store shareable benchmark music derived from a shareable benchmark music table 302 located within the local music investment server portion 301. It should be noted that shareable benchmark music stored within the local music investment server portion 301 may be provided by an individual that does not utilize a peer-tuner 200, such as, but not limited to, the music artist. Transmission of shareable benchmark music from the local music investment server portion 301 to the local peer-tuner portion 201 is represented by transmission line 322.

The local peer-tuner portion 201 comprises a music profile string table 208, wherein the music profile string table 208 comprises unique music identifications (IDs), each of which is discussed below. Specifically, the unique music IDs are either benchmark music IDs 212 or peer obtained music IDs 214. As mentioned above, the benchmark music IDs 212 are derived from the user benchmark music database 202. Benchmark music IDs 212 are globally unique identifiers of benchmark music that may be utilized to identify the benchmark music.

Benchmark music IDs allow an individual listening to shareable benchmark music to purchase benchmark music simply by forwarding the benchmark music ID to a location or device capable of completing an order for the music associated with the benchmark music ID. Specifically, as is further described below, the benchmark music ID may be utilized by the user of a computer system comprising the peer-tuner 200 to identify the benchmark music to the local music investment server 300 for purchasing. The local music investment server 300 may then order a physical copy (i.e., CD, cassette, etc.) of the benchmark music to be provided to the user. Alternatively, the local music investment server 300 may be utilized to download all music located within a CD, having the benchmark music therein, to the purchasing user. Transmission line 222 demonstrates that benchmark music IDs may originate from a remote peer-tuner portion 401 of a remote computer system. Further discussion of benchmark music IDs 212 and derivation is provided below.

Benchmark music IDs located within the music profile string table 208 are associated with specific user actions that may also be stored within the music profile string table 208. The user actions comprise, but are not limited to, the actions, “buy,” “block,” “skip,” and/or “none.”Because shareable benchmark music 204 and the benchmark music IDs 212 are by definition derived from music that the user has purchased, the associated user action for the benchmark music ID 212 is “buy.” The other associated user actions, which pertain to remote peer obtained IDs 214, will be discussed hereafter.

The local peer-tuner portion 201 (FIG. 1) also maintains a remote peer connection list 216, which comprises the address (i.e., Internet protocol (IP) address) of one or more remote computer systems having therein remote peer-tuner portions 401. The remote computer system may be located within a network having therein the computer system 102 associated with the present local peer-tuner portion 201. Preferably, the remote peer connection list is saved in order of best matching peer to worst matching peer, wherein the word “peer” represents the computer system on which a peer-tuner portion is located. The remote peer connection list stores the peer addresses for future use. Herein, the best matching peer in a first computer system is a remote computer system having a peer-tuner portion with music stored therein, wherein the stored music is most similar to the musical taste of the user of the first computer system. To the contrary, a worst matching peer is a computer system having a peer-tuner portion that has stored therein music least similar to the taste of the user of a computer system on which the remote peer connection list is located. Alternatively, the best matching peer in a first computer system is a remote computer system having a peer-tuner portion with music stored therein, wherein the stored music is most similar to the musical taste of the user of the first computer system.

If a user purchases benchmark music and obtains listening rights to the benchmark music, information further identifying the benchmark music is downloaded to the music profile string table 208 for use by the purchasing user. Such information may include the title, artist, and/or producer of the purchased benchmark music. If the purchaser has obtained distribution rights to the purchased benchmark music, the purchased benchmark music may be considered shareable benchmark music. Therefore, the peer-tuner 200 may transmit the shareable benchmark music located within the local peer tuner portion 201 of the database 106 to remote peer-tuner portions 401 associated with remote peers listed within the remote peer connection list. It should be noted however, that when shareable benchmark music is transmitted between a local peer-tuner portion 201 and a remote peer-tuner portion 401, the information further identifying the benchmark music (i.e., title, artist, etc.) is not transmitted with the shareable benchmark music.

Peer-tuners 200 that are active within the same network also transmit the address (i.e., IP address) of the computer system 102 on which they are located, to an active peers table 318 located within the local music investment server portion 301 of the database 106. The peer-tuner 200 also transmits the benchmark music IDs 212, located within the music profile string table 208, to a benchmark music IDs table 316 located within the local music investment server portion 301, as demonstrated by transmission line 324.

Other portions of the music investment server portion 301 of the database 106 include a music buyer account table 304, a music seller account table 306, a music investor account table 308, a music purchase data table 312 and a music investment data table 314, each of which is discussed below. It should also be noted that the remote peer-tuner portion 401 comprises the same portions as the peer-tuner portion 201 located within the present computer system 102 (FIG. 1).

In accordance with an alternative embodiment of the invention, instead of having a separate peer-tuner application 200 (FIG. 2) and a peer-tuner portion 201 of the database 106, a peer-tuner device may be located within the computer system 102 (FIG. 1), or external to the computer system 102 (FIG. 1) that comprises the peer-tuner application 200 (FIG. 2) and the peer-tuner portion 201 of the database 106. In addition, instead of having a separate music investment server application 300 (FIG. 2) and a music investment server portion 301 of the database 106, a music investment server device may be located within the computer system 102 (FIG. 1), or external to the computer system 102 that comprises the music investment server application 300 (FIG. 2) and the music investment server portion 301 of the database 106.

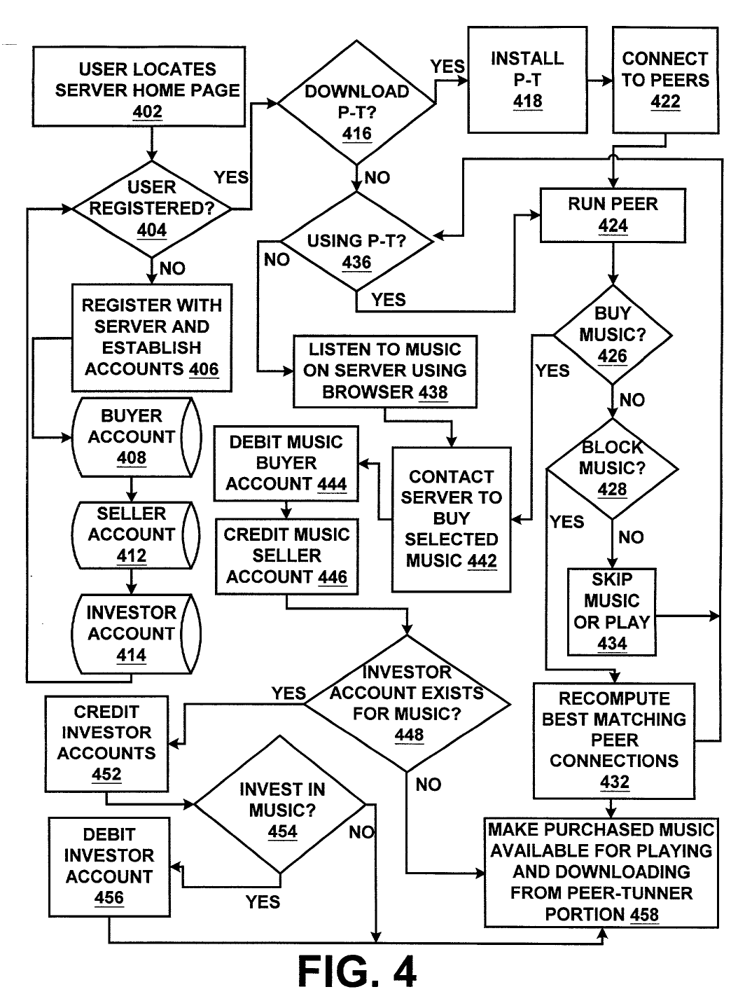

FIG. 4 is a flowchart that further illustrates interaction between a user, the peer-tuner 200 (FIG. 2), and the music investment server 300 (FIG. 2). In this regard, each block represents a module, segment, or portion of code, which comprises one or more executable instructions for implementing the specified logical function(s). It should also be noted that in some alternative implementations, the functions noted in the blocks may occur out of the order noted. For example, two blocks shown in succession may in fact be executed substantially concurrently or the blocks may sometimes be executed in the reverse order, depending upon the functionality involved, as will be further clarified below.

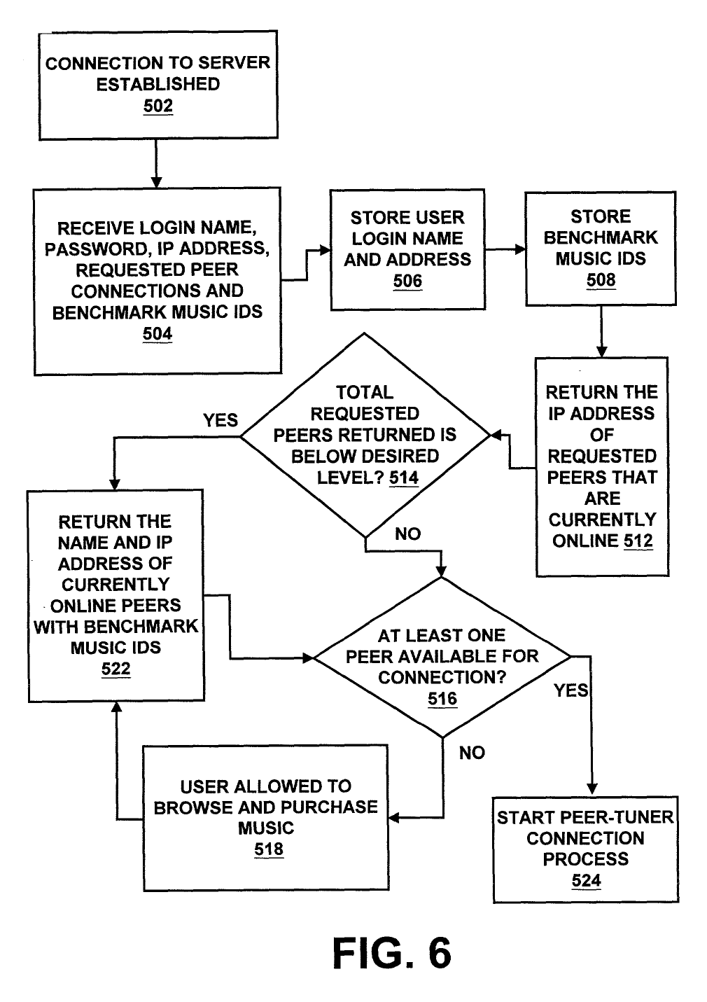

As shown by block 402, a user initiates interaction between the peer-tuner 200 and the music investment server 300 by utilizing a Web browser to navigate the Internet until a music investment server home page is located. Any method of locating the music investment home page may be utilized such as, but not limited to, utilizing an IP address, typing a uniform resource locator (URL) within the Web browser, or using a search engine on the Internet. It should be noted that the process of logging into the music investment server 300 (FIG. 2) is discussed in further detail with reference to FIG. 6.

When the user is connected to the server home page, the music investment server 300 determines if the user has previously registered for use of the home page (block 404). If the user has not previously registered, the user is required to register to use the music investment server 300 (block 406). Registration for use of the music management server 300 may be performed via numerous different means including, but not limited to, registering on the server home page. Examples of information required for registration may include a user name and password, credit card information, and/or any other information for facilitating music purchasing.

A series of options are then made available to the user via the server homepage. A first option is for the user to open a music buyer account (block 408). If the user opens a music buyer account, the user name and password, or other information required during registration, is stored within the music buyer account table 304 of the local music investment server portion 301. A second option is for the user to open a music seller account (block 412). A user may wish to open a music seller account if they are a musician, record company, or other supplier of music. If the user opens a music seller account, the user name and password, or other information required during registration is stored within the music seller account table 306 of the local music investment server portion 301. It should be noted that online legal documents and/or forms relating to creative rights and music investment may also be required during registration.

A third option is for the user to open a music investor account (block 414). A user may wish to open a music investor account if they wish to invest in music they have previously heard, wherein the music has been stored in either the local peer-tuner portion 201 or in the local music investment server portion 301. If the user opens a music investor account, the user name and password, financial information necessary for facilitating investment transactions, and/or other information required during registration, is stored within the music investor account table 306 of the local music investment server portion 301.

When it is confirmed that the user is registered, the user is provided with the option to download the peer-tuner 200 to their computer system (block 416). It is not necessary that the user download and use the peer-tuner 200 in order to listen to or invest in music located on the music investment server portion 301 of the database 106. However, if the user does elect to download the peer-tuner 200 to their computer system, the user is preferably guided through an installation process for installing the peer-tuner after it has been downloaded to their computer system (block 418). After installation of the peer-tuner to the remote location, the remote peer-tuner attempts to connect to other peer-tuners (block 422) including the local peer-tuner 200. Connection to other peer-tuners may be performed via a PCI slot located within the remote computer system or via any other means of connecting computer systems for transmission of information.

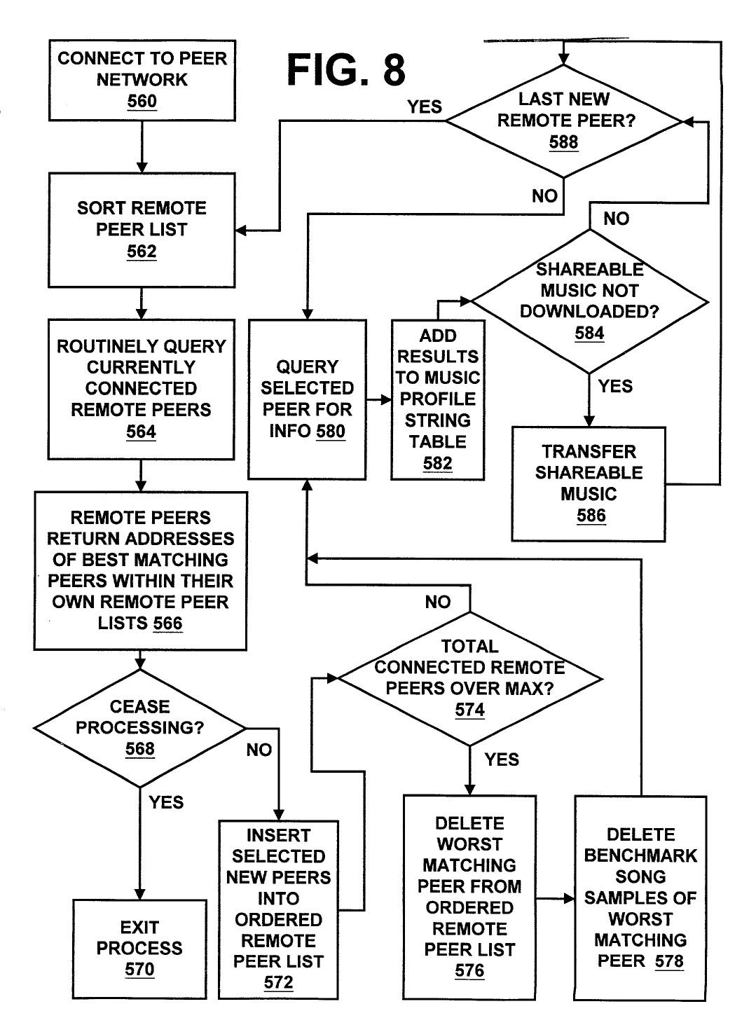

After connecting to other peers, the peer-tuner 200 (FIG. 1) begins running in autonomous background mode as shown by process block 424. Autonomous background mode is described in detail with reference to FIG. 8. During autonomous background mode, the user may also listen to shareable benchmark music located within the music temporary cache table 206 (FIG. 3).

A determination is then made as to whether the user wishes to purchase the shareable benchmark music listened to, wherein the shareable benchmark music has been received by the music temporary cache table 206 (FIG. 3), from the benchmark music database 202 located within the local peer-tuner portion 201 (block 426). The determination as to whether the user wishes to purchase heard benchmark music may be made by the user in numerous ways, such as, but not limited to, selecting a “purchase music” option within the server home page. If the user wishes to purchase the benchmark music he/she is currently listening to, the music investment server 300 (FIG. 1) is contacted by the computer being utilized by the user, as shown by block 442.

If the user does not wish to buy the music they are listening to, the user may elect to block the downloaded music from being played again (block 428). If the user desires to block the music, the music profile string table 208 located on the remote peer-tuner 401 is modified so as to remove the benchmark music ID associated with the benchmark music that is to be blocked, and the shareable benchmark music is removed from the music temporary cache table 206. The remote peer connection list 216 located within the remote peer-tuner 401 is then modified to reflect removal of the peer-tuner music sample (block 432) by shifting position of peers located within the remote peer connection list 216.

If the user has not elected to block or buy music while it is being played, then the user is either skipping the music or allowing it to play to completion as shown by process block 434. When a user either skips benchmark music or allows it to play to completion, their music profile string table 208 is not modified and the song sample remains in the music temporary cache table 206.

As mentioned above, it is not necessary that the user downloads and uses the peer-tuner 200 in order to listen to or invest in music located on the music investment server portion 301 of the database 106. In fact, if the user elects not to download the peer-tuner 200 a determination is made as to whether the user wishes to use the peer-tuner 200. If the user wishes to use the peer-tuner 200, as may be determined by the user selecting an option to use the peer-tuner 200 made available on the server home page, the peer-tuner 200 begins running in autonomous background mode as shown by process block 424.

If the user selects not to use the peer-tuner 200 located on their computer system, the user may instead elect to listen to shareable benchmark music 302 (FIG. 3) directly from the local music investment server portion 301 (FIG. 3) (block 438). Listening to the shareable benchmark music 302 (FIG. 3) may be accomplished through a Web browser or a different means of connecting to the computer system 102 (FIG. 1) to receive the shareable benchmark music 302 (FIG. 3).

It should be noted that at any point, the music investment server 300 might be contacted for purposes of purchasing currently selected benchmark music (block 442). Typically, contacting the music investment server 300 for purchasing is performed during the course of listening to the shareable benchmark music 302 (FIG. 3), via the server home page or an alternate method. It should be noted, however, that contacting the music investment server 300 for purchasing may be performed whenever the user is able to identify and select specific benchmark music for purchase via use of the music investment server 300. As mentioned above, if the user wishes to purchase the benchmark music they are currently listening to, the music investment server 300 (FIG. 1) is contacted by the computer being utilized by the user, as shown by block 442.

If, however, the peer tuner 200 is not used, the user is still capable of listening to and/or purchasing benchmark music by searching or browsing benchmark music via the music investment server 300. To search or browse benchmark music, the user may utilize criteria such as benchmark music download popularity or investment status.

When a user purchases benchmark music, the music buyer account table 304 (FIG. 3) located within the local music investment server 301 is debited (block 444) by subtracting the cost to purchase the music from a total amount allocated to the user. Preferably, the user has previously allocated a specific amount for his/her account balance, which is stored in the music buyer account table 304 (FIG. 3).

When benchmark music is purchased by a user (hereafter, the music purchaser), the music seller account table 306 (FIG. 3) is credited (block 446) for the amount of the purchase made by the music purchaser. Crediting of the music seller account table 306 (FIG. 3) may be performed by simply adding the amount charged for the purchase of the benchmark music by the music purchaser to a total amount stored within the music seller account table 306 (FIG. 3). The music investment server 300 (FIG. 2) then determines if a music investor account exists within the music investor account table 308 (FIG. 3) for the benchmark music selected by the music purchaser (block 448). If music investor accounts exist for the selected musical piece, the music investor accounts are credited appropriately to reflect purchasing of the selected benchmark music (block 452).

The music investment server 300 (FIG. 2) then determines if the music purchaser is an investor in the selected musical piece. If the music purchaser is not an investor in the selected musical piece, the music purchaser is given the option to invest in the selected musical piece (block 454). If the music purchaser does wish to invest in the selected musical piece, a music investor account is opened within the music investor account table 308 (FIG. 3), in the name of the music purchaser. If the music purchaser decides to invest in the musical piece, the music investor account assigned to the music purchaser is debited (block 456) to account for an amount required to become an investor in the purchasing profits for the selected musical piece.

After the benchmark music has been purchased, assuming the music purchaser is given appropriate rights (i.e., copyright, distribution rights, etc.), the benchmark music is stored within the benchmark music database 202 for playing and downloading by other peers (block 458). Specifically, the shareable purchased benchmark music is made available in the benchmark music database 202 for alternate users to play and download to their own music temporary cache tables via their own peer-tuners 200, after a connection has been made between the music purchaser's remote peer-tuner portion 401 and the alternate user's peer-tuner 200.

In accordance with one embodiment of the invention, the music temporary cache table 206 (FIG. 3) may be provided so that individual benchmark music files located within the music temporary cache table 206 (FIG. 3) are exposed to the direct control of the user of the peer-tuner 200. As mentioned above, the benchmark music may be downloaded into a monolithic secure locker file that protects the benchmark music from being individually extracted, played, and saved using the file management capabilities of the computer device hosting the peer tuner. If the benchmark music is downloaded into a monolithic secure locker file, the act of purchasing benchmark music would extract the purchased benchmark music from the locker file, identify the benchmark music via categories such as, but not limited to, artist, title, and label, and make the musical selection independently playable from the peer-tuner utilized by the user.

When a locker file is utilized, a user faced with the risk of a favorite benchmark musical selection, that has not yet been purchased, being deleted from the locker file because an associated peer connection was dropped, may have a greater urgency to purchase the benchmark music when the user decides that the benchmark music is enjoyable. In addition, by not making titles and/or artist names available to the user during the course of listening to downloaded shareable benchmark music, an urgency to purchase the benchmark music after listening to the benchmark music is further compounded since the benchmark music may not be easily obtainable from other sources without the title and/or artist names.

It should be noted that the commercial process of the music management and investment system does not exclude music retailers and/or online stores. As mentioned above, the purchase method may be devised for users of a local-peer 200 to physically take delivery of the uncompressed, highest quality version of the benchmark music purchased at a retail location. Since it is typical that the highest quality versions of music may be found stored within a CD or other storage medium, a retail location may accept a coupon or other form of proof of purchase generated for the user purchasing music online, by the music management and investment system, which is provided to the user after such purchase.

While one of many benefits provided by the present music management and investment system if providing a process that encourages music listeners to purchase music, the process of a user being able to invest in music heard is also beneficial. It should be noted that the amount required for investing in the success of a musical selection (hereafter, profit cost), and the manner in which profits from sales of music online (hereafter, profit sharing), may be provided in many different embodiments. The following provides an example of a profit cost and profit sharing structure that may be utilized to implement the present music management and investment system.

If a music supplier assumes that he/she would obtain five thousand (5000) purchases and downloads of a specific benchmark musical selection at one dollar per download, he/she might price the option to download the benchmark musical selection at five thousand dollars ($5,000) for one hundred percent (100%) of the download rights to the benchmark musical selection. If a user purchased one percent (1%) of the download royalty rights for fifty dollars ($50) and the benchmark musical selection actually obtained ten thousand (10,000) download purchases, the investor would receive one hundred dollars ($100), or a one hundred percent (100%) return on their fifty dollar ($50) investment. It should be noted that a small transaction commission could be charged by the server making the benchmark music available for downloading, thereby maintaining a viable business model.

The number of users that buy and invest in specific benchmark music selections may be made public via the music investment server 300 (FIG. 2). Publication of the number of users that buy and invest in specific benchmark music not only provides an investing tool that demonstrates public interest in the benchmark music, but the published numbers also provide a better representation of public interest in specific benchmark music.

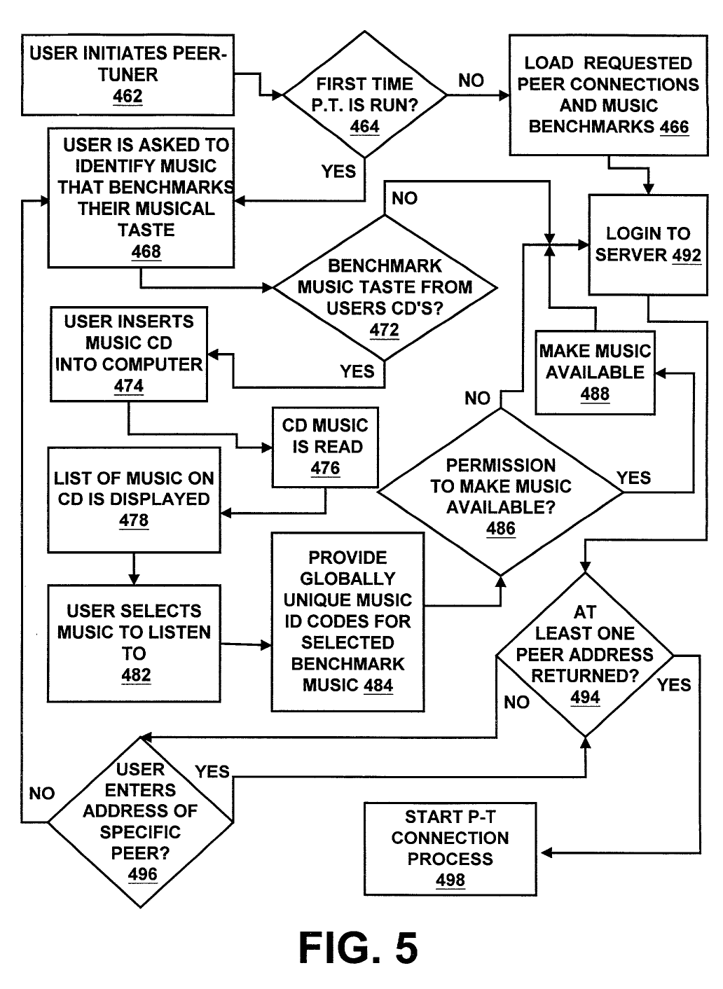

FIG. 5 is a flowchart that further illustrates installation and initialization of the peer-tuner 200 (FIG. 2). A user first initiates the peer-tuner 200 (FIG. 2) by downloading and running the peer tuner software that is executable on the downloading computer (block 462). A determination is then made as to whether this is the first time the peer tuner 200 (FIG. 2) has been initiated (block 464) on the computer system storing the peer tuner 200 (FIG. 2). This determination may be made by determining whether benchmark music exists in the music temporary cache table. If it is determined that this is the first time the peer-tuner 200 (FIG. 2) has been initiated, the user is asked to identify music that benchmarks their musical taste (block 468), which, in turn, is stored within the benchmark music database 202 (FIG. 3). The shareable benchmark music 204 (FIG. 3) stored within the benchmark music database 202 (FIG. 3) may be from any storage medium owned by the user such as, but not limited to, a CD. If, however, it is not the first time the peer-tuner 200 (FIG. 2) has run, the peer-tuner 200 (FIG. 2) logs into the music investment server 300 (FIG. 2) (block 492).

The following assumes, for demonstration purposes, that a CD is utilized as the storage medium. It should be noted, however, that other storage mediums, such as, but not limited to, a zip drive, a floppy disk, a record, etc., may also be utilized. If, after a determination has been made (block 472), the user elects to identify benchmark music from their CD collection, the user inserts their music CD into their computer system 102 (FIG. 1) (block 474). As shown by block 476, the peer-tuner 200 (FIG. 2) reads the music. Of course, other parts of the computer system 102 (FIG. 1) may be utilized to read music from the CD. A playable list of musical selections made available by the CD is displayed to the user (block 478). Since track song titles are generally not available on CDs, it is beneficial for the user to be able to listen to each musical track on the CD before identifying it as a benchmark musical selection.

As shown by block 482, the user then selects and flags benchmark musical selections from the CD. The benchmarked musical selections are provided with a globally unique benchmark musical selection ID 212 (FIG. 3) (block 484) that is based on a uniform calculation, or process, being applied to the musical data identified by the CD. The musical data might be the checksum and/or file size of a musical selection either prior or after compression of the musical selection. Compression of the musical selection may be provided in many different formats, such as, but not limited to, MP3, or a different compression format. To the extent that uncompressed musical data for a specific musical selection is the same for CDs on which the musical selection has been recorded, the calculated music ID codes for the musical selection should be the same regardless of when and where ID codes were uniformly calculated.

As shown by block 486, a determination is made as to whether the user has permission from the legal copyright owner of the musical selection, to make the benchmark music available for downloading within the shareable benchmark music sample table 204 (FIG. 3). Preferably, the owner of the copyright is the individual that creates the musical selection samples, although others having listening and distribution permission from the copyright holder may make the benchmark music available for downloading by remote peers. One instance in which the benchmark music may be provided by the copyright owner is when a musician owning the copyright in a musical selection places their own musical selection samples, directly on the local music investment server portion 301 (FIG. 3) of the database 106 (FIG. 3), as well as on the local peer-tuner portion 201 (FIG. 3) of the database 106 (FIG. 3).

If the copyright owner has granted permission to make the benchmark music available for downloading by remote peers, the peer tuner saves the benchmark music into the benchmark music database 202 (FIG. 3) (block 488). If permission has not been granted, then only the corresponding globally unique benchmark music ID 212 (FIG. 3) for the benchmark musical selection is shareable. After making music available for download (block 488), after determining that permission has been granted, the peer-tuner 200 (FIG. 2) logs into the music investment server 300 (FIG. 2) (block 492).

A determination is then made as to whether at least one peer address has been returned to the peer-tuner 200 (block 494). The music investment server 300 is expected to return to the peer tuner 200 the connection address of at least one peer tuner. If, however, the connection address of at least one peer-tuner is not returned, the user is given the opportunity to enter a peer-tuner address in order to connect to any known peer tuner (block 496). Since it is possible that the music investment server did not return the connection address of at least one peer tuner because the user did not have a sufficient number of benchmark musical selections available, the user will also be given the opportunity to enter more benchmark songs (block 468). In these cases, the login process to the music investment server will be restarted. If however, a peer-tuner address is entered by the user, the check for at least one peer tuner address is repeated (block 494), after which the peer-tuner connection process is started (block 498).

FIG. 6 is a flowchart further illustrating the process of logging into the music investment server 300 (FIG. 2) and resulting actions performed by the music investment server 300 (FIG. 2) and peer-tuner 200 (FIG. 2). Logging into the music investment server 300 (FIG. 2) begins when a peer establishes a connection to the music investment server 300 (FIG. 2) (block 502). The purpose of logging into the music investment server 300 (FIG. 3) is to find remote peers that are currently online which share matching benchmark music IDs 212 (FIG. 3) with the peer that is logging into the music investment server 300 (FIG. 2). Knowledge of addresses for peers belonging to users that have purchased and enjoy the same music enables peers to build the interconnecting network.

As shown by process block 504, the music investment server 300 (FIG. 1) receives a login name, password, current IP address, requested peer connections, and/or song benchmark IDs from the peer logging onto the music investment server 300. The music investment server 300 (FIG. 2) stores the obtained login name and current IP address in the active peers table 318 (FIG. 3) (block 506). The benchmark music IDs 212 (FIG. 3) are stored in the benchmark music IDs table 316 (FIG. 3) (block 508). Preferably, shareable benchmark music 204 (FIG. 3) is not uploaded to the music investment server 300 (FIG. 1). Instead, the shareable benchmark music 204 (FIG. 3) remains within each individual peer-tuner portion 201 (FIG. 3) where the shareable benchmark music 204 (FIG. 3) is accessible to remote peers. Of course, the shareable benchmark music may also, or otherwise, be uploaded to the music investment server portion 301 (FIG. 3).

As shown by block 512, the music investment server 300 (FIG. 3) returns IP addresses of active peers currently online to the peer establishing a connection. A determination is then made as to whether the total number of active peers currently online is below a predefined threshold (block 514). If the number of active peers currently online is below the predetermined threshold, the music investment server 300 (FIG. 2) returns the name and IP address of each active peer currently online, to the peer, as well as benchmark music IDs 212 (FIG. 3) associated with each active peer (block 522).

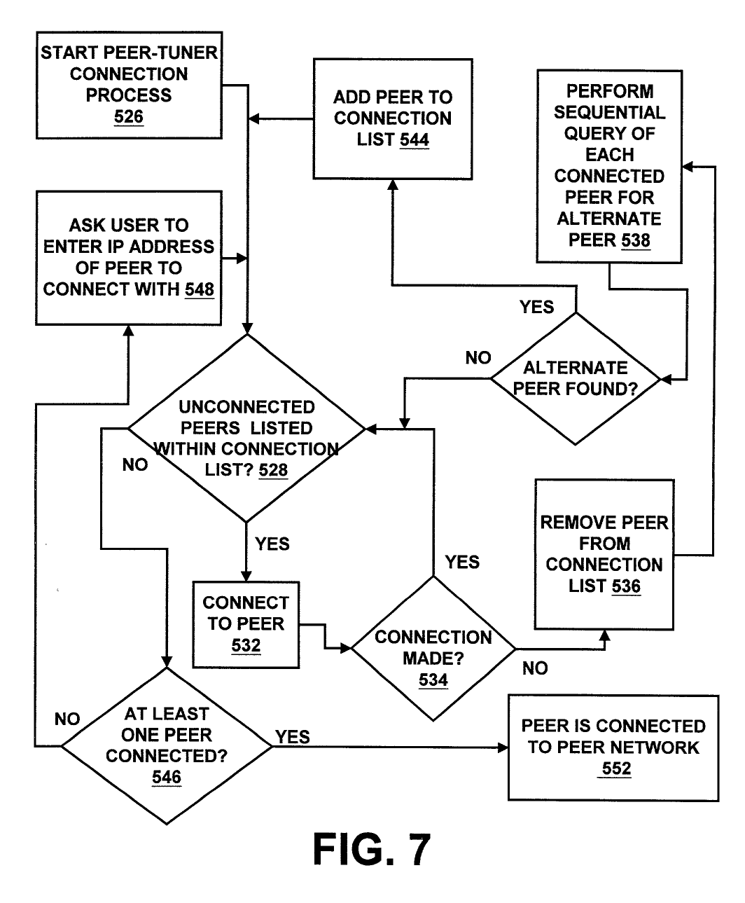

After returning the names and IP addresses (block 522), a determination is made as to whether there are any active peers currently online (block 516) for connecting to the requesting peer. The determination of whether there are active peers currently online (block 516) is also performed if the total number of active peers currently online is not below a predefined threshold. If there are no active peers currently online for connection, the user is still allowed to browse and purchase music associated with the shareable benchmark music 302 (FIG. 3) that is made available on the local music investment server portion 301 (FIG. 3) (block 518). It should be noted that purchasing of the benchmark music allows the user to obtain the benchmark music ID 212 (FIG. 3) associated with the music. However, if at least one peer is available for connection, a peer-tuner 200 connection process begins (block 524). The peer-tuner connection process is further described with reference to FIG. 7.

To reiterate, shareable benchmark music 302 (FIG. 3) stored within the local music investment server portion 301 (FIG. 3) of the database 106, as well as shareable benchmark music stored on a peer tuner 204 is preferably associated with an agreement limiting downloading and redistribution of the benchmark music 302 (FIG. 3). As an example, the agreement might state that the music samples 302 (FIG. 3) may not be redistributed. This type of agreement could be protected by making the music temporary cache table 206 a secure music locker, so that benchmark music can not be extracted and saved using the file management capabilities of the host hardware of the peer tuner. It should be noted, however, that it is not necessary for a user to purchase benchmark music 302 (FIG. 3) stored on the music investment server portion 301 (FIG. 3) in order to be connected to the peer-tuner network, if the user has uploaded benchmark music IDs 212 (FIG. 3) that are matched to any benchmark music IDs 316 (FIG. 3) stored within the local music investment server portion 301 (FIG. 3).

The shareable benchmark music 302 (FIG. 3) that is made available via the music investment server portion 301 (FIG. 3) is preferably stored with an associated benchmark music ID, the total number of people that have purchased the music associated with the benchmark music, and the number of people that have purchased the benchmark music having peers that are currently online. Not only do the above statistics assist a peer in finding connections to a peer network, but the statistics also provide a means for users to identify, listen to, and purchase the benchmark music made available by the local music investment server portion 301, that is most popular.

FIG. 7 is a flowchart further illustrating connection of a peer-tuner 200 (FIG. 3) with a peer network formed from a list of available online remote peers. As mentioned with reference to the flowchart of FIG. 6, if at least one remote peer is available for connection, the peer-tuner 200 connection process is started (block 526). The peer-tuner 200 (FIG. 3) determines if unconnected remote peers are still listed within the remote peer connection list 216 (FIG. 3) (block 528).

If unconnected remote remote peers are still listed within the remote peer connection list 216 (FIG. 3), the peer-tuner 200 (FIG. 2) attempts to connect to the unconnected remote peer (block 532). Connection to the unconnected remote peer may be performed via use of transmission control protocol/Internet protocol (TCP/IP) or a similar protocol. Of course, other methods of connection may also be utilized. A determination is then made as to whether the attempted connection was successful (block 534). If the attempted connection is not successful the peer-tuner 200 (FIG. 2) removes the unconnected remote peer from the remote peer connection list 216 (FIG. 3) (block 536). If, however, the attempted connection is successful, the peer-tuner 200 (FIG. 3) determines if there are other unconnected remote peers still listed within the remote peer connection list 216 (FIG. 3) (block 528).

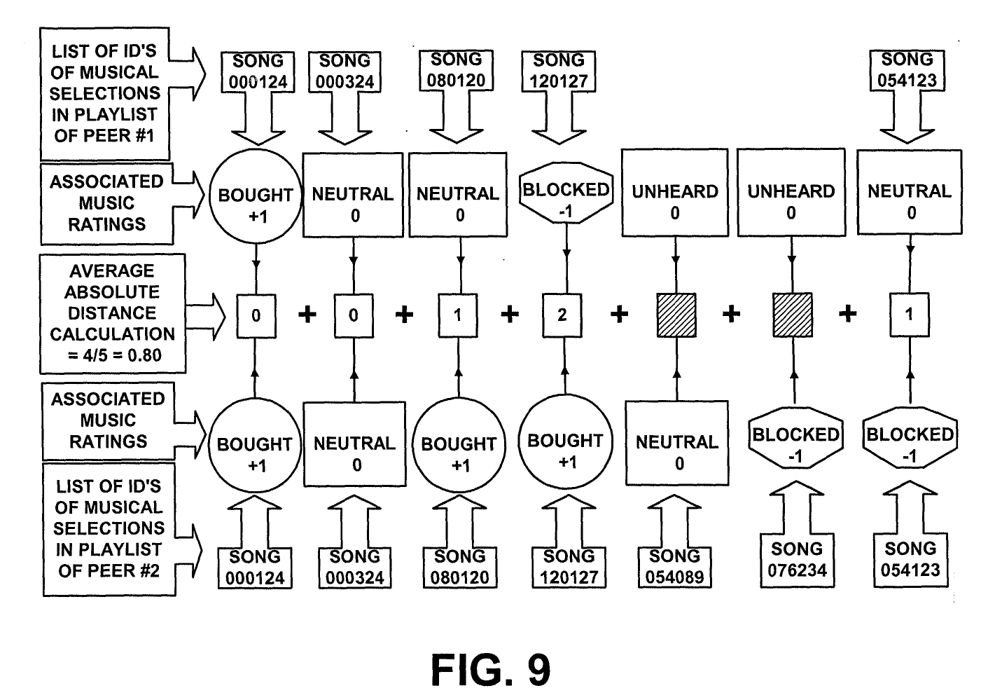

As shown by block 538, the peer-tuner 200 (FIG. 2) then performs a sequential query of each connected online peer for a closest matching alternate peer. The procedure utilized to determine a closest matching alternate peer is described in detail with reference to FIG. 9 provided below. If an alternate peer is found, the alternate peer is added to the remote peer connection list 216 (FIG. 3) (block 544). The peer-tuner 200 (FIG. 2) then continues to check if unconnected peers exist within the remote peer connection list 216 (FIG. 3), and the processes described in block 532, 534, 536, 538, and 544 are repeated until no unconnected peers remain within the remote peer connection list 216 (FIG. 3).

If there are no unconnected remote peers within the remote peer connection list 216 (FIG. 3) the peer-tuner 200 (FIG. 2) determines if at least one remote online peer is connected (block 546) to the peer-tuner 200 (FIG. 2). If there are no remote peers connected to the peer-tuner 200 (FIG. 2), the peer-tuner 200 (FIG. 2) prompts the user to manually enter the address (i.e., IP address) of a remote peer for connection (block 548). An example of when there may be no remote peers connected to the peer-tuner 200 (FIG. 2) is when the music investment server 300 (FIG. 1) is offline during checking for at least one remote online peer connection. If, however, at least one remote online peer is connected to the peer-tuner 200 (FIG. 2), the process for connecting remote peers to the peer-tuner 200 (FIG. 2) is complete and the peer-tuner 200 (FIG. 2) is run in autonomous mode (block 552).

The peer-tuner 200 (FIG. 2) may be run simultaneously in both autonomous and user interactive modes in order to find music that optimally matches user taste. The autonomous mode of operation is described with reference to the flowchart of FIG. 8, which is described below. As shown by FIG. 8, to run in autonomous mode, the peer-tuner 200 (FIG. 2) is connected to a peer network (block 560). As shown by block 562, the peer-tuner 200 (FIG. 2) sorts its now connected remote peers, within the remote peer connection list 216 (FIG. 3) in an order that has the remote peer having the closest match to the musical taste of the user of the peer-tuner 200 (FIG. 2) listed first. The closest match calculations make use of both the peer-tuner 200 (FIG. 3) and the music profile string table 208 (FIG. 3) of the remote peer, wherein the music profile string table may comprise a list of musical selections that the respective user of the remote peer has purchased, has blocked from playing, or has a neutral opinion about. An algorithm that may be utilized to determine the closeness of a match between a user musical taste and remote peers is shown with reference to FIG. 9, although it should be noted that a least means squared calculation may be utilized.

To continually improve the quality of peer connections with respect to user musical taste, currently connected remote peers are routinely queried to determine which peer within each remote peer connection list 216 (FIG. 3) most closely matches the musical taste of the user of the querying remote peer (block 564). The remote peers then return addresses of best matching peers within their own remote peer connection lists 216 (FIG. 3) (block 566) to the peer-tuner 200 (FIG. 2). As shown by block 568, the peer-tuner 200 (FIG. 3) determines if processing of remote peers may be ceased. Processing may be ceased (block 570) if queries are not successful or if the user wishes to discontinue operation of the peer-tuner 200 (FIG. 3).

If processing of the remote peers is not to be ceased, the selected new remote peers are inserted into the ordered remote peer connection list 216 (FIG. 3) (block 572). A determination is then made as to whether the total number of connected remote peers is above a maximum threshold (block 574). If the total number of connected remote peers is above the maximum threshold, the worst matching remote peer is deleted from the remote peer connection list 216 (FIG. 3) (block 576). Moreover, as mentioned above, the shareable benchmark music of the worst matching remote peer is deleted from the music temporary cache table 206 (FIG. 3) (block 578). Since the music data may also be associated with another remote peer listed in the remote peer connection list 216 (FIG. 3), each benchmark music selection is reference counted to prevent removal of the benchmark music if a still connected remote peer has the benchmark music therein.

The new remote peer(s) are then queried for benchmark IDs and information stored within the music profile string table 208 (FIG. 3) (block 580). The information received is included within the music profile string table 208 (FIG. 3) of the currently selected peer (block 582). The music profile string table 208 (FIG. 3) of the currently selected peer is examined to determine if shareable benchmark music associated with the information received has not yet been downloaded to the currently selected peer (block 584). If shareable benchmark music associated with the information received has not yet been downloaded to the currently selected peer, the peer-tuner 200 (FIG. 2) begins to download the shareable benchmark music 204 (FIG. 3) (block 586).

A determination is then made as to whether the peer-tuner 200 (FIG. 3) has reached the last new remote peer within the remote peer connection list 216 (FIG. 3) (block 588). If the peer-tuner 200 (FIG. 3) has not reached the end of the remote peer connection list 216 (FIG. 3), the next connected remote peer in the list is queried for information stored within the music profile string table 208 (FIG. 3) (block 580). Blocks 580 through 588 are continued until the last new remote peer within the remote peer connection list 216 (FIG. 3) has been reached. After the last new remote peer has been reached, the autonomous process begins a new cycle of improving the quality of the remote peer connection list 216 (FIG. 3) (block 562).

Platforms utilized to provide communication among peer-tuners 200 (FIG. 2) and the music investment server 300 (FIG. 2) are not limited to well known networks such as the Internet and wireless telephony. Other platforms might include, but are not limited to, Bluetooth, Part 15 wireless, infrared, satellite, and/or cable. It should also be noted that it is not necessary for the peer-tuners 200 (FIG. 2) be physically separate from one another. Peer-tuners may be virtualized and stored on one location within a server. In such an embodiment, a user might contact the server using a telephone dialup connection and listen to benchmark music interactively by modulating the benchmark music with dual tone multi-frequency (DTMF) tones. This may even be used in an intelligent music on hold service, where caller id references a user music profile string table located on the server, and wherein the server intelligently plays music types that the user on hold enjoys most.

FIG. 9 is a block diagram illustrating how one peer-tuner 200 (FIG. 2) calculates how closely its associated music profile string table 208 (FIG. 3) matches the music profile string table 208 (FIG. 3) associated with another peer. A music profile string 208 table (FIG. 3) is comprised of a list of benchmark musical selections, or songs, ID codes that are created from benchmark music IDs 212 (FIG. 3), as well as the peer obtained music IDs 214 (FIG. 3).

The possible user actions taken on benchmark music stored within the music temporary cache table 206 (FIG. 3) that was downloaded and played from a connected peer are “buy”, “block”, “skip”, and “none.” The action associated with the benchmark music IDs 214 (FIG. 3) is obviously “buy.” If a user wishes to stop a musical selection from playing again, the user action would be “block.” If, however, the user skips a benchmark musical selection, or song, in mid-play without buying or blocking, the action would be “skip.” In addition, if the user is ambivalent about the song and allows it to play to completion, the user action is “none.” Within the calculations shown by FIG. 9, the user actions “skip” and “none” are equivalent, and are identified as “neutral” actions which do not affect calculation results.

In comparing the music profile string table 208 (FIG. 3) between peers, many musical selections purchased via one peer will be unheard via another peer. Musical selections that both peers have purchased are included in the musical taste algorithm, referred to herein as an average absolute distance calculation. Specifically, the average absolute distance calculation utilizes a least mean squared calculation to provide an absolute distance calculation between two peers, as is shown by FIG. 9. The greater the average absolute distance between peers, the greater is the assumed difference in musical tastes between the users of the two peers. While the general concept would remain the same, it is conceivable that the weights or calculations of the algorithm could change in order to improve the desired results.

The average absolute distance calculations will help peer-tuners 200 (FIG. 1) gravitate to other peers that have similar types of music available. By incorporating this calculation within the peer-tuner, it should be noted that users of the peer-tuner do not have to do any complex rating of music in order to improve their listening experience since the peer-tuner automatically performed the rating.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

The following is claimed:

1. A local system for providing music management and investment opportunities, comprising:
a memory comprising a peer-tuner application and a music investment server application;
a local database comprising a local peer-tuner portion and a local music investment server portion; and
a processor programmed by said peer-tuner application and said music investment server application, wherein,
said processor is programmed by said peer-tuner application to perform the steps of:
connecting said local system with at least one remote system having said peer-tuner application therein;
allowing a user of said local system to download benchmark music received from said remote system to said local peer-tuner portion of said local database, after connecting said local system with said remote system, wherein said benchmark music received by said local system, from said remote system, is removed from said local peer-tuner portion of said local database when said connection between said local system and said remote system is ended; and
allowing said user to purchase said benchmark music received from said remote system, and
wherein said processor is programmed by said music investment server to perform the steps of:
providing said user of said remote system with an option to purchase said benchmark music; and
allowing a user of said local system or said remote system to invest in potential sales of said benchmark music, wherein said investment entitles said user to a portion of funds received from purchasing of said benchmark music.

2. The system of claim 1, wherein said local peer-tuner portion of said database further stores therein, a benchmark music identification code that identifies said benchmark music, wherein said benchmark music identification code is capable of being utilized to identify said benchmark music to said music investment server application for purposes of purchasing said benchmark music.

3. The system of claim 2, wherein downloading of said benchmark music from said remote system to said local peer-tuner portion of said local database is accompanied by transmission of said benchmark music identification code from said remote system to said local peer-tuner portion of said local database, and wherein said music identification code is removed from said local peer-tuner portion of said local database when said downloaded benchmark music is removed from said local peer-tuner portion of said local database.

4. The system of claim 1, wherein said processor is further programmed by said music investment server application to open and regulate a series of user accounts.

5. The system of claim 4, wherein said series of user accounts comprise a music buyer account, said music buyer account being debited by said music investment server application when said user purchases benchmark music.

6. The system of claim 4, wherein said series of user accounts comprise a music investor account, said music investor account being credited by said music investment server application when said benchmark music is purchased.

7. The system of claim 4, wherein said series of user accounts comprise a music seller account, said music seller account being credited by said music investment server application when said user purchases benchmark music.

8. The system of claim 1, wherein said processor is further programmed by said music investment server application to perform the step of determining if a user of said remote system is registered to interact with said music investment server application.

9. The system of claim 1, wherein said peer-tuner application further provides said user with the option to block downloaded music received from said remote system from being played again.

10. The system of claim 1, wherein said processor is further programmed by said music investment server application to provide said user of said remote system with an option to download said peer-tuner application to said remote system.

11. The system of claim 1, wherein purchasing of said benchmark music by said user of said local peer-tuner application, assuming said user of said local peer-tuner application has distribution rights to said benchmark music, results in said benchmark music being made available within said local peer-tuner portion of said local database for downloading by said remote peer-tuner application after a connection has been made between said remote system and said local system.

12. The system of claim 1, wherein said processor is further programmed by said music investment server application to allow a user of said local system to listen to benchmark music stored within said local music investment server portion of said local database.

13. The system of claim 1, wherein said processor is further programmed by said local peer-tuner application to create a list of remote peers within said local peer-tuner portion of said local database, a remote peer being a remote computer system having therein benchmark music that is similar in musical taste to the user of the local computer system.

14. The system of claim 13, wherein said processor is further programmed by said local peer tuner application to remove a remote peer from said list of remote peers if benchmark music located within said remote computer system is no longer similar in musical taste to the user of the local computer system, said removal of said remote peer resulting in removal of benchmark music from said remote computer system.

15. A first peer-tuner for providing using management and investment opportunities, comprising:
a memory comprising a peer tuner application;
a local database; and
a processor programmed by said peer-tuner application to perform the steps of:
connecting said first peer-tuner to a second peer-tuner; and
allowing a user of said first peer-tuner to download benchmark music received from said second peer-tuner to said local database, after connecting said first peer-tuner with said second peer-tuner, wherein said benchmark music received by said local database is removed from said local database when said connection between said first peer-tuner and said second peer-tuner is ended.

16. The first peer-tuner of claim 15, wherein said local database further stores therein, a benchmark music identification code that identifies said benchmark music, wherein said benchmark music identification code may be utilized for purposes of purchasing said benchmark music.

17. The first peer-tuner of claim 15, wherein downloading of said benchmark music from said second peer-tuner to said local database is accompanied by transmission of said benchmark music identification code from said second peer-tuner to said local database, and wherein said music identification code is removed from said local database when said downloaded benchmark music is removed from said first peer-tuner.

18. The first peer-tuner of claim 15, wherein said first peer-tuner further provides said user with the option to block downloaded music received from said second peer-tuner from being played again.

19. The first peer-tuner of claim 15, wherein said first peer-tuner provides a user of said first peer-tuner with an option to purchase said benchmark music, wherein purchasing of said benchmark music by said user of said first peer-tuner, assuming said user of said first peer-tuner has distribution rights to said benchmark music, results in said benchmark music being made available within said local database for downloading by said second peer-tuner after a connection has been made between said first peer-tuner and said second peer-tuner.

20. The first peer-tuner of claim 15, wherein said processor is further programmed by said peer-tuner application to create a list of remote peer-tuners having benchmark music therein that is similar in musical taste to the user of the first peer-tuner.

21. The first peer-tuner of claim 20, wherein said processor is further programmed by said peer tuner application to remove a remote peer-tuner from said list of remote peer-tuners if benchmark music from said remote peer-tuner is no longer similar in musical taste to the user of the first peer-tuner, said removal of said remote peer-tuner resulting in ending connection between the first peer-tuner and the remote peer-tuner.

22. A method of providing music management and investment opportunities, comprising the steps of:
connecting a local system with at least one remote system;
allowing a user of said local system to download benchmark music received from said remote system to said local system, after connecting said local system with said remote system, wherein said benchmark music received by said local system, from said remote system, is removed from said local system when said connection between said local system and said remote system is ended;
allowing said user to purchase said benchmark music received from said remote system; and
allowing a user of said local system or said remote system to invest in potential sales of said benchmark music, wherein said investment entitles said user to a portion of funds received from purchasing of said benchmark music.

23. The method of claim 22, further comprising the step of said local system storing therein, a benchmark music identification code that identifies said benchmark music, wherein said benchmark music identification code is capable of being utilized to identify said benchmark music for purposes of purchasing said benchmark music.

24. The method of claim 22, wherein said step of downloading further comprises the step of transmitting said benchmark music identification code from said remote system to said local system, and removing said music identification code from said local system when said downloaded benchmark music is removed from said local system.

25. The method of claim 22, further comprising the step of opening and regulating user accounts.

26. The method of claim 25, wherein said series of user accounts comprise a music buyer account, said music buyer account being debited by said local system when said user purchases benchmark music.

27. The method of claim 25, wherein said series of user accounts comprise a music investor account, said music investor account being credited by said local system when said benchmark music is purchased.

28. The method of claim 25, wherein said series of user accounts comprise a music seller account, said music seller account being credited by said local system when said benchmark music is purchased.

29. The method of claim 22, wherein purchasing of said benchmark music by said user of said local system, assuming said user of said local system has distribution rights to said benchmark music, results in said benchmark music being made available within said local system for downloading by said remote system after a connection has been made between said remote system and said local system.

30. The method of claim 22, further comprising the step of creating within said local system a list of remote systems having benchmark music therein that is similar in musical taste to said user of said local system.

31. The method of claim 30, further comprising the step of said local system removing a remote system from said list of remote systems if benchmark music located within said remote system is no longer similar in musical taste to the user of the local system, said removal of said remote system resulting in removal of benchmark music from said remote computer system from said local system.

32. A system for providing music management and investment opportunities, comprising:
means for connecting a local system with at least one remote system;
means for allowing a user of said local system to download benchmark music received from said remote system to said local system, after connecting said local system with said remote system, wherein said benchmark music received by said local system, from said remote system, is removed from said local system when said connection between said local system and said remote system is ended;
means for allowing said user to purchase said benchmark music received from said remote system; and
means for allowing a user of said local system or said remote system to invest in potential sales of said benchmark music, wherein said investment entitles said user to a portion of funds received from purchasing of said benchmark music.
